(19) United States
(12) Patent Application Publication
(10) Pub. No.: US 2019/0197977 A1
(43) Pub. Date: Jun. 27, 2019

(54) SCAN SIGNAL COMPENSATING METHOD, SCAN SIGNAL COMPENSATING CIRCUIT AND DISPLAY DEVICE

(71) Applicant: Xianyang Caihong Optoelectronics Technology Co., Ltd, Xianyang (CN)

(72) Inventor: YUAN-LIANG WU, XIANYANG (CN)

(21) Appl. No.: 16/221,924

(22) Filed: Dec. 17, 2018

(30) Foreign Application Priority Data
Dec. 21, 2017 (CN) 2017113919906

(51) Int. Cl. G09G 3/36

(52) U.S. Cl. CPC G09G 3/3677; G02F 1/1362

(57) ABSTRACT

The application relates to a scan signal compensating method, a scan signal compensating circuit and a display device. The method includes: obtaining an accumulated working time of a display device; acquiring at least one compensation voltage value from a look-up table according to the accumulated working time; and adjusting at least one DC voltage inputted to the GOA driving circuit according to the at least one compensation voltage value. That is, by counting the accumulated working time of the display device, searching a pre-stored look-up table according to the accumulated working time to determine the compensation voltage value and adjusting the related voltage value(s) of the GOA driving circuit according to the compensation voltage value, the problems of ghost and flicker in the display device caused by drain current drifts of some TFTs in the GOA driving circuit suffered from long-term bias voltages are suppressed consequently.

### FIELD OF THE DISCLOSURE

The disclosure relates to the field of display technologies, and more particularly to a scan signal compensating method, a scan signal compensating circuit and a display device.

### BACKGROUND

With the development of thin film transistor liquid crystal display (TFT-LCD) devices, the competition of liquid crystal products has become more and more fierce, and various manufacturers begin to develop new technologies to occupy the market. The technology of gate driver on array (GOA) integrates a gate driver on a glass substrate to achieve the function of panel scanning. Due to its low cost, low power consumption, narrow border and other advantages, it has gradually become a new research direction of manufacturers. In the development of GOA technology, most focus on the research of driving circuits to realize large-size and high-resolution applications.

Referring to FIG. 1 and FIG. 2, FIG. 1 is a schematic structural diagram of a TFT in a GOA region provided in related art, and FIG. 2 is a schematic diagram of I-V characteristic curves of a selected TFT in the GOA region in related art. For properties of an amorphous silicon TFT itself, as long as there is a voltage difference between the gate and the source/drain for a long time, the I-V characteristic of the TFT would be changed, that is, a drain current I_{D} drifts/changes under the same gate-source voltage V_{GS}. For the GOA region, in a practical application of using the amorphous silicon TFT, a gate-source voltage is kept at a low level and a source-drain voltage is kept at a high level for a long time, which would affect charging states of pixels caused by drift of scan driving voltage outputted from a scan driving circuit, resulting in a display effect of LCD panel is degraded, for example, a phenomenon of image ghost may appear.

### SUMMARY

On such basis, the disclosure provides a scan signal compensating method, a scan signal compensating circuit and a display device, so as to solve the above problem existing in related art.

In the disclosure, a scan signal compensating method is provided. Exemplarily, the method is adapted for a GOA driving circuit and includes steps of: obtaining an accumulated working time of a display device; acquiring at least one compensation voltage value from a look-up table according to the accumulated working time; and adjusting at least one DC voltage inputted into the GOA driving circuit according to the at least one compensation voltage value to compensate a scan signal outputted from the GOA driving circuit.

In an embodiment, the at least one compensation voltage value includes a first DC voltage adjustment value, a second DC voltage adjustment value and a third DC voltage adjustment value; correspondingly, the step of acquiring at least one compensation voltage value from a look-up table according to the accumulated working time includes: acquiring the first DC voltage adjustment value, the second DC voltage adjustment value and the third DC voltage adjustment value applied for the GOA driving circuit from the look-up table according to the accumulated working time.

In an embodiment, the look-up table includes a mapping relationship between the accumulated working time and the at least one compensation voltage values; and the mapping relationship is expressed as that:

$$\{ \begin{matrix}{dV}_{T 1 / 2} \_vgl = {f}_{1} ( T ) ; \\ dQ\_vss 1 = {f}_{2} ( T ) ; \\ dQ\_vss 2 = {f}_{2} ( T ) ;\end{matrix}$$

where dV_{T1/2}_{_}vgl refers to the first DC voltage adjustment value, dQ_vss1 refers to the second DC voltage adjustment value, dQ_vss2 refers to the third DC voltage adjustment value, T refers to the accumulated working time.

In an embodiment, the at least one compensation voltage value includes a first DC voltage adjustment value and a second DC voltage adjustment value; correspondingly, the step of acquiring at least one compensation voltage value from a look-up table according to the accumulated working time includes: acquiring the first DC voltage adjustment value and the second DC voltage adjustment value applied for the GOA driving circuit from the look-up table according to the accumulated working time.

In an embodiment, the look-up table includes a mapping relationship between the accumulated working time and the at least one compensation voltage value; and the mapping relationship is expressed as that:

$$\{ \begin{matrix}{dV}_{T 1 / 2} \_vgl = {f}_{1} ( T ) ; \\ dQ\_vss = {f}_{2} ( T ) ;\end{matrix}$$

where dV_{T1/2}_{_}vgl refers to the first DC voltage adjustment value, dQ_vss refers to the second DC voltage adjustment value, T refers to the accumulated working time.

The disclosure further provides a display device. The display device includes: a GOA driving circuit; a recording module configured to acquire an accumulated working time of the display device; a searching module configured to find at least one compensation voltage value from a look-up table according to the accumulated working time; and a compensating module, configured to adjust at least one DC voltage inputted into the GOA driving circuit according to the at least one compensation voltage value.

In an embodiment, the at least one compensation voltage value includes a first DC voltage adjustment value, a second DC voltage adjustment value and a third DC voltage adjustment value; correspondingly, the searching module concretely is configured to find the first DC voltage adjustment value, the second DC voltage adjustment value and the third DC voltage adjustment value applied for the GOA driving circuit from the look-up table according to the accumulated working time.

In an embodiment, the at least one compensation voltage value includes a first DC voltage adjustment value and a second DC voltage adjustment value; correspondingly, the searching module concretely is configured to find the first DC voltage adjustment value and the second DC voltage adjustment value applied for the GOA driving circuit from the look-up table according to the accumulated working time.

The disclosure further provides a scan signal compensating circuit. The circuit is arranged in a display and includes a processor and a memory. The memory is configured for storing a pre-designed look-up table, and the look-up table includes mapping relationships between accumulated working times and compensation voltage values. The processor is electrically connected to the memory, a timing control circuit of the display device and a GOA driving circuit of the display device. The processor is configured for obtaining a current working time from a timer of the timing control circuit, finding a previous accumulated working time from the memory, calculating a current accumulated working time based on the obtained current working time and the previous accumulated working time, finding at least one compensation voltage value according to the current accumulated working time and sending the at least one compensation voltage value to the GOA driving circuit for voltage compensation.

In an embodiment, the look-up table is formed according to drifts of drain currents of a first TFT, a second TFT and a third TFT of the GOA driving circuit.

In summary, the embodiments of the disclosure count the accumulated working time of the display device, search a pre-stored look-up table according to the accumulated working time to determine the compensation voltage value(s), and adjust the related voltage value(s) of the GOA driving circuit according to the compensation voltage value(s), the problems of image ghost and flicker caused by leakage of pixel capacitors in the active area resulting from drifts of I-V characteristic curves of TFTs in the GOA region can be overcome consequently.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the drawings:

FIG. 1 is a schematic structural view of a TFT in a GOA region in related art;

FIG. 2 is a schematic view showing I-V characteristic curves of a certain selected TFT in the GOA region in related art;

FIG. 3 is a schematic view showing a circuit structure of a display device according to an embodiment of the disclosure;

FIG. 4 is a schematic flowchart of a scan signal compensating method according to an embodiment of the disclosure;

FIG. 5 is a schematic structural view of a stage of GOA driving circuit according to an embodiment of the disclosure; and

FIG. 6 is a schematic structural view showing a scan signal compensating circuit according to an embodiment of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”, “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The disclosure will be further described in detail with reference to accompanying drawings and preferred embodiments as follows.

### Embodiment 1

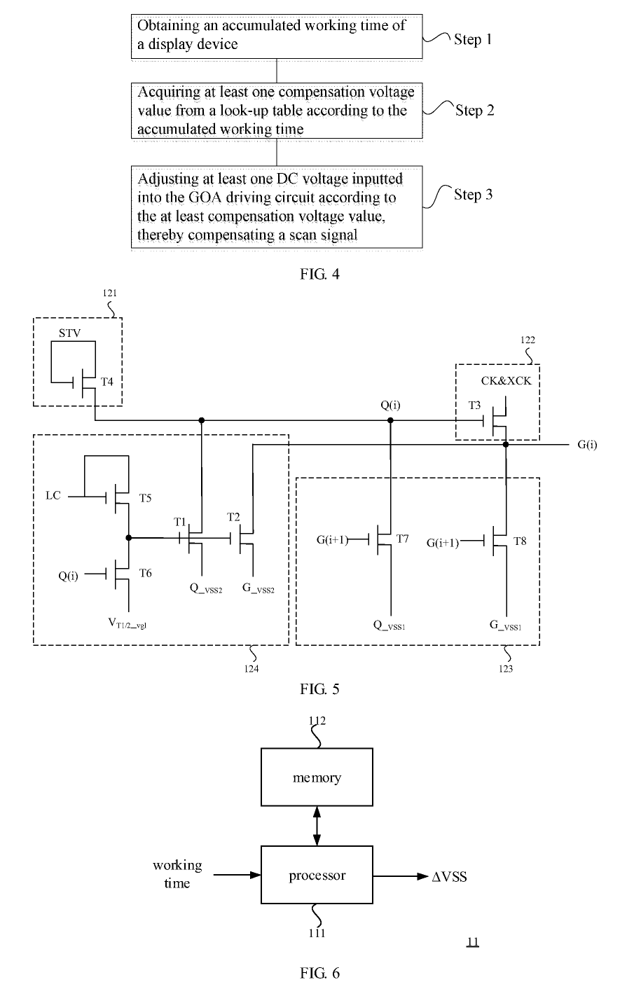

Please referring to FIG. 3 and FIG. 4, FIG. 3 is a schematic view showing a circuit structure of a display device 10 according to the embodiment of the disclosure, and FIG. 4 is a schematic flowchart of a scan signal compensating method according to the embodiment of the disclosure. In particular, the compensating method is suitable for a TFT-LCD display device, and its working principle is also suitable for other display devices such as a LED display device, an OLED display device, or the like. The method can effectively solve a problem of insufficient pixel charging caused by a drift of I-V characteristic of a TFT in a GOA region suffered from a long-term bias voltage during working.

Specifically, the display device 10 may include a scan signal compensating circuit 11, GOA driving circuits 12, a timing control circuit 13, a data driving circuit 14 and a pixel matrix 15. The scan signal compensating circuit 11 is electrically connected to the GOA driving circuits 12 and the timing control circuit 13. The scan signal compensating circuit 11 is configured (i.e., structured and arranged) for obtaining working times in a time period from a timer of the timing control circuit 13, calculating an accumulated working time, generating a compensation voltage value for the GOA driving circuits 12 according to the accumulated working time and sending the compensation voltage value to the GOA driving circuits 12, thereby ensuring that the scan signals outputted from the GOA driving circuits 12 are stable. In other words, the scan signal compensating circuit 11 includes: a recording module configured to acquire an accumulated working time of the display device, a searching module configured to find at least one compensation voltage value from a look-up table according to the accumulated working time, and a compensating module configured to adjust at least one DC voltage inputted into the GOA driving circuit according to the at least one compensation voltage value.

More specifically, the scan signal compensating method is implemented by the above scan signal compensating circuit 11 and may include the following steps i.e., Step 1, Step 2 and Step 3.

Step 1, acquiring an accumulated working time of a display device.

Step 2, finding a compensation voltage value(s) from a look-up table according to the accumulated working time.

Step 3, adjusting a DC voltage(s) inputted into the GOA driving circuit according to the compensation voltage value(s) to compensate a scan signal.

In particular, for the recording of working time of the display device, it may start a timing when the display device is powered on and end the timing when the display device is powered off, so that one working time for one time power on is recorded and then is accumulated with previous accumulated working time to form a total working time. In other embodiment, it may start recording the accumulated working time when the display device is powered on. The manner of recording the accumulated working time is not limited herein.

In the exemplary embodiment, by counting the accumulated working time of the display device, using a pre-stored look-up table to find the compensation voltage value corresponding to the accumulated working time and adjusting a related voltage value(s) of the GOA driving circuit according to the compensation voltage value, which can eliminate problems of image ghost and flicker in the display device caused by drain current drifts of some TFTs in the GOA driving circuit suffered from long-term bias voltages.

### Embodiment 2

Referring to FIG. 5 and FIG. 6, FIG. 5 is a schematic structural view of a GOA driving circuit according to an embodiment of the disclosure, and FIG. 6 is a schematic structural view of a scan signal compensating circuit according to an embodiment of the disclosure. Based on the above embodiment, this embodiment focuses on a working principle of the scan signal compensating circuit and a corresponding scan signal compensating method, and details are described as follows.

First, the GOA driving circuit 12 mainly includes a pull-up control unit 121, a pull-up unit 122, a pull-down unit 123 and a pull-down maintaining unit 124. The pull-up control unit 121 mainly includes a fourth TFT T4 and is configured for receiving a scan signal of a preceding stage of GOA driving circuit and generating a scan control signal Q(i) for controlling the operation of the pull-up unit 122. The pull-up unit 122 mainly includes a third TFT T3 and is configured for transmitting a turn-on voltage VGH formed by clock signals CK&XCK to a scan line G(i) under the control of the scan control signal Q(i). The pull-down unit 123 mainly includes a seventh TFT T7 and an eighth TFT T8 and is configured for transmitting a turn-off voltage VGL formed by a DC source voltage value G_vss (G_vss1, G_vss2) to the scan line G(i) under the control of a succeeding stage of scan signal G(i+1). The pull-down maintaining unit 124 mainly includes a first TFT T1, a second TFT T2, a fifth TFT T5 and a sixth TFT T6 and is configured for making the TFT T1 and the TFT T2 be ON states under the control of a low-frequency signal LC to maintain the scan control signal Q(i) at a low voltage level.

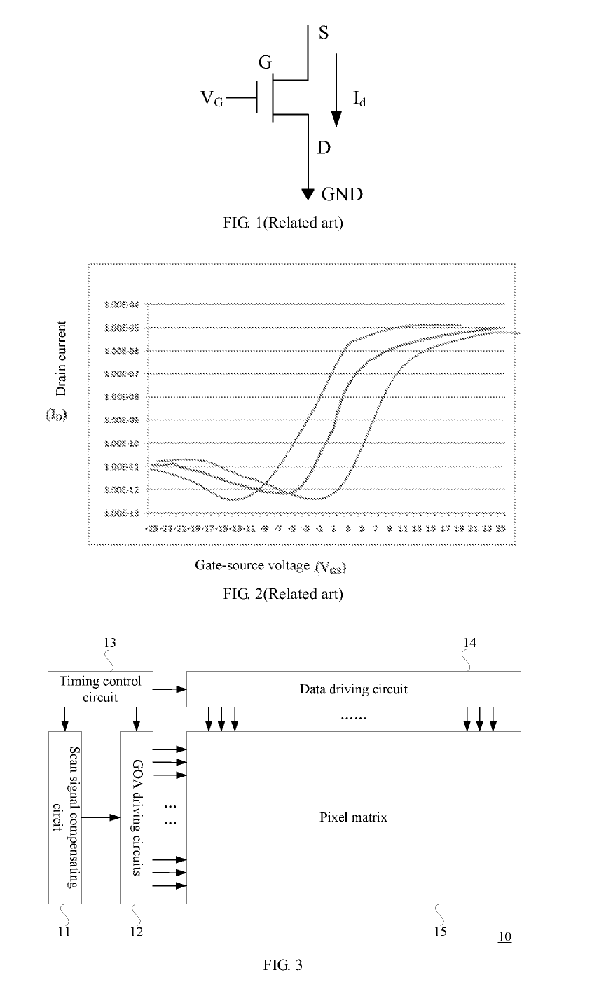

Based on experimental analysis, TFTs suffered from long-term voltage differences mainly include the first TFT T1, the second TFT T2 and the third TFT T3, voltage parameters related thereto mainly include the clock signals CK&XCK, the low frequency signal LC, a first DC voltage value V_{T1/2}_{_}vgl, a second DC voltage value Q_vss1, a third DC voltage value Q_vss2, a fourth DC voltage value G_vss1 and a fifth DC voltage value G_vss2. Working conditions of gates, drains and sources of the first TFT T1, the second TFT T2 and the third TFT T3 can be estimated/deduced by the inputted clock signals CK&XCK, low frequency signal LC and DC source voltage values VSS (including the first DC voltage value V_{T1/2}_{_}vgl, the second DC voltage value Q_vss1, the third DC voltage value Q_vss2, the fourth DC voltage value G_vss1 and the fifth DC voltage value G_vss2). That is, situations of these TFTs suffered from bias voltages can be determined by estimation or deduction. Since the long-term bias voltage would affect drain currents I_{D} of these TFTs, as shown in FIG. 2, which would directly affect a voltage amplitude of driving signal outputted by the scan line G(i). That is, the turn-on voltage VGH and the turn-off voltage VGL will be changed in some degree, thereby affecting the charging of pixels in the active area. Therefore, it is necessary to adjust the DC source voltage value VSS inputted into the GOA driving circuit 12 periodically according to the time.

Specifically, the scan signal compensating circuit 11 may include a processor 111 and a memory 112. The memory 112 stores a look-up table (LUT for short) with compensation voltage values, and a DC voltage adjustment value ΔVSS needed to be inputted into the GOA driving circuit 12 for compensation along with the change of time can be searched from the LUT.

Furthermore, when the processor 111 is powered on, the processor 111 acquires current working time from a timer of the timing control circuit 13 and reads a previous accumulated working time from the memory 112, and then the current working time and the previous accumulated working time are accumulated to from a current total working time. Afterwards, the LUT is retrieved from the memory 112 and a corresponding LUT value is searched from the LUT according to the current total working time. Herein, the LUT value includes the DC voltage adjustment value ΔVSS for compensation, and then the DC voltage adjustment value ΔVSS is sent to the GOA driving circuit via a power management chip (PMIC), so as to achieve an adjustment of a scan signal outputted by the GOA driving circuit.

It is emphasized that, the adjustment of the DC voltage value VSS may be performed in a period of time from power on to power off. That is, in the period of time from power on to power off, the accumulated working time is counted, and then the voltage adjustment value is determined according to the LUT. When the display device is powered on next time, an adjustment using the DC voltage adjustment value ΔVSS is started immediately, and the adjustment is completed before the active area (AA) starts displaying. Of course, the adjustment using the DC voltage adjustment value may be performed in real time instead in a particular period, for example, in the period of the display device being powered on, a display image being switched or a signal source being switched. There is no restriction herein. It can be understood that the adjustment performed after one time power on and power off has relatively better effect.

In this embodiment, based on a pre-stored LUT, the voltage adjustment value is found according to the accumulated working time of the display device, which can realize flexible adjustment of the DC voltage value VSS and thereby solve the problems of image ghost and flicker cased by I-V characteristic curve drifts of TFTs in the GOA driving circuit.

### Embodiment 3

Referring to FIG. 5 again, this embodiment focuses on the LUT in detail based on the above embodiments. Specifically, the LUT needs to be stored in advance in a memory of the scan signal compensating circuit. The LUT is a group of data obtained by estimating I-V characteristics of the first TFT T1, the second TFT T2 and the third TFT T3 in advance during the operation of the GOA driving circuit, i.e., drift condition of drain currents of the TFTs suffered from long-term bias voltages. According to the drift condition, input voltage values such as a first DC voltage adjustment value dV_{T1/2}_{_}vgl, a second DC voltage adjustment value dQ_vss1 and a third DC voltage adjustment value dQ_vss2 inputted into the GOA driving circuit are adjusted totally.

Referring to the Table 1 below, according to the drift condition of the drain currents of the first TFT T1, the second TFT T2 and the third TFT T3, the first DC voltage adjustment value dV_{T1/2}_{_}vgl, the second DC voltage adjustment value dQ_vss1 and the third DC voltage adjustment value DQ_vss2 are adjusted. After adjustment, the first DC voltage value V_{T1/2}_{_}vgl=V_{T1/2}_{_}vgl+dV_{T1/2}_{_}vgl, the second DC voltage value Q_vss1′=Q_vss1+dQ_vss1, and the third DC voltage value Q_vss2′=Q_vss2+dQ_vss2. For example, when the accumulated working time of the display device is t∈(T1˜T2), the first DC voltage value V_{T1/2}_{_}vgl′ should be adjusted to be equal to V_{T1/2}_{_}vgl+dV_{T1/2}_{_}vgl1, the second DC voltage value Q_vss11 is adjusted to be equal to Q_vss1+dQ_vss11, the third DC voltage value Q_vss2′ should be adjusted to be equal to Q_vss2+dQ_vss21. These reference voltages are used to adjust the scan signal outputted from the GOA driving circuit to ensure its output stability.

TABLE 1

| Time (h) | dV_{T1/2}_{_{—}}vgl | dQ_vss1 | dQ_vss2 |
|---|---|---|---|
| T1~T2 | dV_{T1/2}_{_{—}}vgl1 | dQ_vss11 | dQ_vss21 |
| T2~T3 | dV_{T1/2}_{_{—}}vgl2 | dQ_vss12 | dQ_vss22 |
| T3~T4 | dV_{T1/2}_{_{—}}vgl3 | dQ_vss13 | dQ_vss23 |
| T4~T5 | dV_{T1/2}_{_{—}}vgl4 | dQ_vss14 | dQ_vss24 |
| . . . | . . . | . . . | . . . |
| . . . | . . . | . . . | . . . |

The LUT table may be a curve formed by fitting, and can be expressed as that:

$$\{ \begin{matrix}{dV}_{T 1 / 2} \_vgl = {f}_{1} ( T ) ; \\ dQ\_vss 1 = {f}_{2} ( T ) ; \\ dQ\_vss 2 = {f}_{2} ( T ) ;\end{matrix}$$

Where dV_{T1/2}_{_}vgl refers to the first DC voltage adjustment value, dQ_vss1 refers to the second DC voltage adjustment value, dQ_vss2 refers to the third DC voltage adjustment value, T refers to the accumulated working time, f1, f2 and f3 are corresponding relationships formed by fitting.

Of course, for the GOA driving circuit shown in FIG. 5, the second DC voltage input terminal (the terminal for inputting voltage Q_vss1) and the third DC voltage input terminal (the terminal for inputting voltage Q_vss2) can be provided by a same DC voltage source. The DC voltage source for example provides a DC voltage value Q_vss, that is, Q_vss=Q_vss1=Q_vss2. At this time, please refer to the following Table 2, according to the drift condition of the drain currents of the first TFT T1, the second TFT T2 and the third TFT T3, the first DC voltage adjustment value dV_{T1/2}_{_}vgl and the second DC voltage adjustment value dQ_vss (the original dQ_vss1 and dQ_vss2 are replaced by dQ_vss herein) are adjusted. After adjustment, the adjusted first DC voltage value is V_{T1/2}_{_}vgl′=V_{T1/2}_{_}vgl+dV_{T1/2}_{_}vgl, and the adjusted second DC voltage value is Q_vss′=Q_vss+dQ_vss. For example, when the accumulated working time of the display device is t∈(T4˜T5), the first DC voltage value V_{T1/2}_{_}vgl′ should to be adjusted to be equal to V_{T1/2}_{_}vgl+dV_{T1/2}_{_}vgl4, and the second DC voltage value Q_vss′ is adjusted to be equal to Q_vss+.dQ_vss4.

TABLE 2

| Time (h) | dV_{T1/2}_{_{—}}vgl | dQ_vss |
|---|---|---|
| T1~T2 | dV_{T1/2}_{_{—}}vgl1 | dQ_vss1 |
| T2~T3 | dV_{T1/2}_{_{—}}vgl2 | dQ_vss2 |
| T3~T4 | dV_{T1/2}_{_{—}}vgl3 | dQ_vss3 |
| T4~T5 | dV_{T1/2}_{_{—}}vgl4 | dQ_vss4 |
| . . . | . . . | . . . |
| . . . | . . . | . . . |

The LUT table may be a curve formed by fitting, and can be expressed as that:

$$\{ \begin{matrix}{dV}_{T 1 / 2} \_vgl = {f}_{1} ( T ) ; \\ dQ\_vss = {f}_{2} ( T ) ;\end{matrix}$$

Where dV_{T1/2}_{_}vgl refers to the first DC voltage adjustment value, dQ_vss refers to the second DC voltage adjustment value, T refers to the accumulated working time, f1, f2 and f3 are corresponding relationships formed by fitting.

In addition, the LUT values are related to the TFT bias voltage direction and TFT structural characteristics, so it is necessary to store LUT values in accordance with the structural characteristics of TFTs in the GOA region for different display devices. It should be understood that, device parameters of TFTs for establishing the LUT may be not exactly the same as the device parameters of the TFTs of the GOA region, in the case of just a small influence on driving voltage and driving current. Of course, it is relatively better that device parameters of the TFTs for establishing the LUT are fully the same as that of the respective TFTs in the GOA region.

The above examples are just for the GOA driving circuit shown in FIG. 5. The idea and working principle of the disclosure can also be applied to other GOA driving circuits, and of course can be applied to other gate driving circuits such as COF circuits.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A scan signal compensating method adapted for a gate driver on array (GOA) driving circuit, wherein the method comprises:
obtaining an accumulated working time of a display device;
acquiring at least one compensation voltage value from a look-up table according to the accumulated working time; and
adjusting at least one direct current (DC) voltage inputted into the GOA driving circuit according to the at least compensation voltage value, thereby compensating a scan signal outputted from the GOA driving circuit.

2. The method according to claim 1, wherein the at least one compensation voltage value comprises a first DC voltage adjustment value, a second DC voltage adjustment value and a third DC voltage adjustment value; correspondingly, acquiring at least one compensation voltage value from a look-up table according to the accumulated working time comprises:
acquiring the first DC voltage adjustment value, the second DC voltage adjustment value and the third DC voltage adjustment value applied for the GOA driving circuit from the look-up table according to the accumulated working time.

3. The method according to claim 2, wherein the look-up table comprises a mapping relationship between the accumulated working time and the at least one compensation voltage values; the mapping relationship is expressed as that:
$$\{ \begin{matrix}{dV}_{T 1 / 2} \_vgl = {f}_{1} ( T ) ; \\ dQ\_vss 1 = {f}_{2} ( T ) ; \\ dQ\_vss 2 = {f}_{2} ( T ) ;\end{matrix}$$
where dV_{T1/2}_{_}vgl refers to the first DC voltage adjustment value, dQ_vss1 refers to the second DC voltage adjustment value, dQ_vss2 refers to the third DC voltage adjustment value, T refers to the accumulated working time.

4. The method according to claim 1, wherein the at least one compensation voltage value comprises a first DC voltage adjustment value and a second DC voltage adjustment value; correspondingly, acquiring at least one compensation voltage value from a look-up table according to the accumulated working time comprises:
acquiring the first DC voltage adjustment value and the second DC voltage adjustment value applied for the GOA driving circuit from the look-up table according to the accumulated working time.

5. The method according to claim 4, wherein the look-up table comprises a mapping relationship between the accumulated working time and the at least one compensation voltage value; the mapping relationship is expressed as that:
$$\{ \begin{matrix}{dV}_{T 1 / 2} \_vgl = {f}_{1} ( T ) ; \\ dQ\_vss = {f}_{2} ( T ) ;\end{matrix}$$
where dV_{T1/2}_{_}vgl refers to the first DC voltage adjustment value, dQ_vss refers to the second DC voltage adjustment value, T refers to the accumulated working time.

6. A display device comprising a GOA driving circuit, wherein the display device further comprises:
a recording module, configured to acquire an accumulated working time of the display device;
a searching module, configured to find at least one compensation voltage value from a look-up table according to the accumulated working time; and
a compensating module, configured to adjust at least one DC voltage inputted into the GOA driving circuit according to the at least one compensation voltage value.

7. The display device according to claim 6, wherein the at least one compensation voltage value comprises a first DC voltage adjustment value, a second DC voltage adjustment value and a third DC voltage adjustment value; correspondingly, the searching module concretely is configured to find the first DC voltage adjustment value, the second DC voltage adjustment value and the third DC voltage adjustment value applied for the GOA driving circuit from the look-up table according to the accumulated working time.

8. The display device according to claim 6, wherein the at least one compensation voltage value comprises a first DC voltage adjustment value and a second DC voltage adjustment value; correspondingly, the searching module concretely is configured to find the first DC voltage adjustment value and the second DC voltage adjustment value applied for the GOA driving circuit from the look-up table according to the accumulated working time.

9. The display device according to claim 6, wherein the compensating module is configured to adjust the at least one DC voltage inputted into the GOA driving circuit after the display device is powered on and before an active area of the display device starts displaying.

10. A scan signal compensating circuit arranged in a display device and comprising a processor and a memory;
wherein the memory is configured to store a preset look-up table, and the look-up table comprises mapping relationships between accumulated working times and compensation voltage values;
wherein the processor is electrically connected with the memory, a timing control circuit of the display device and a GOA driving circuit of the display device; the processor is configured to obtain a current working time from a timer of the timing control circuit, find a previous accumulated working time from the memory, calculate a current accumulated working time, find at least one compensation voltage value according to the current accumulated working time, and send the at least one compensation voltage value to the GOA driving circuit for voltage compensation.

11. The circuit according to claim 10, wherein the look-up table is formed according to drifts of drain currents of a first TFT, a second TFT and a third TFT of the GOA driving circuit.

12. The circuit according to claim 10, wherein the GOA driving circuit comprises a pull-up control unit, a pull-up unit, a pull-down unit, and a pull-down maintaining unit connected together;
the pull-up control unit comprises a fourth TFT and is configured for receiving a scan signal of a preceding stage of GOA driving circuit and generating a scan control signal;
the pull-up unit comprises a third TFT and is configured for transmitting a turn-on voltage formed by clock signals a scan line under the control of the scan control signal;
the pull-down unit comprises a seventh TFT and an eighth TFT and is configured for transmitting a turn-off voltage formed by a DC source voltage value(s) to the scan line under the control of a succeeding stage of scan signal;
the pull-down maintaining unit comprises a first TFT, a second TFT, a fifth TFT and a sixth TFT, and is configured for keeping the first TFT and the second TFT at ON states under the control of a low-frequency signal to maintain the scan control signal and the scan signal on the scan line at a low voltage level.

13. The circuit according to claim 10, wherein the at least one compensation voltage value comprises a first DC voltage adjustment value, a second DC voltage adjustment value and a third DC voltage adjustment value, a mapping relationship between the current accumulated working time and the at least one compensation voltage value is expressed as that:
$$\{ \begin{matrix}{dV}_{T 1 / 2} \_vgl = {f}_{1} ( T ) ; \\ dQ\_vss 1 = {f}_{2} ( T ) ; \\ dQ\_vss 2 = {f}_{2} ( T ) ;\end{matrix}$$
where dV_{T1/2}_{_}vgl refers to the first DC voltage adjustment value, dQ_vss1 refers to the second DC voltage adjustment value, dQ_vss2 refers to the third DC voltage adjustment value, T refers to the current accumulated working time.

14. The circuit according to claim 10, wherein the at least one compensation voltage value comprises a first DC voltage adjustment value and a second DC voltage adjustment value; a mapping relationship between the current accumulated working time and the at least one compensation voltage value is expressed as that:
$$\{ \begin{matrix}{dV}_{T 1 / 2} \_vgl = {f}_{1} ( T ) ; \\ dQ\_vss = {f}_{2} ( T ) ;\end{matrix}$$
where dV_{T1/2}_{_}vgl refers to the first DC voltage adjustment value, dQ_vss refers to the second DC voltage adjustment value, T refers to the current accumulated working time.
